(19) United States
(12) Patent Application Publication
(10) Pub. No.: US 2012/0192061 A1
(43) Pub. Date: Jul. 26, 2012

(54) SYSTEM AND METHOD FOR MODIFYING A WEBPAGE

(75) Inventors: Noam Fine, Tel Aviv (IL); Joseph Marouani, Tel Aviv (IL)

(73) Assignee: SIMPLYGEN LTD., Ra'anana (IL)

(21) Appl. No.: 13/498,695

(22) PCT Filed: Sep. 27, 2010
(86) PCT No.: PCT/IB10/54342

§ 371 Date: Mar. 28, 2012

Related U.S. Application Data
(60) Provisional application No. 61/246,631, filed on Sep. 29, 2009.

(51) Int. Cl. G06F 17/00

(52) U.S. Cl. 715/235

(57) ABSTRACT

The invention provides a system and method for modifying a webpage. In the system of the invention, a tag classification module classifies tags on the webpage; and a webpage modification module adds one or more predetermined functionalities to the webpage based upon the classification of one or more of the classified tags on the webpage. The functionality added to a webpage by the webpage modification module may be, for example, a menu of items associated with the classification of the tag, one or more activatable images associated with the classification of the tag or a toolbar.

### FIELD OF THE INVENTION

This invention relates to Internet browsing and more particularly, to systems and methods for modifying a webpage.

### BACKGROUND OF THE INVENTION

The term “customized Internet browsing” is used to refer to web-browser software that interacts with user actions and provides a modified browsing experience. An example of customized browsing is the autocomplete feature, which dynamically offers suggested keywords while the user inputs a search phrase into a search tag. The autocomplete feature can ease and simplify the search process,

For many webpage tag attributes there are no binding standards for the values of the attribute, and different webpages can use uses different technologies and tag attribute values. Thus, in the absence of accepted standards, customized browsing has to be tailored to the webpage. For this reason, customized browsing has so far been very limited.

U.S. Pat. No. 7,685,144 to Katragadda discloses a system for automatically generating and maintaining personal data, such as an address book, a financial portfolio, a discussion groups or blogs book, or other types of personal data stores, based on a person's structured search data and/or usage data (e.g., browsing) and/or other sources of personal data (e.g., emails the user receives). Related metadata can also be used in the generating and/or maintaining of the personal data. Dynamic personal data ranking and/or autocomplete functions are also provided, which can be used in conjunction with the automatic generation and maintenance of the user's personal data, to further ease the user's burden in managing and/or handling such data.

U.S. Pat. No. 7,216,292 to Snapper et al. discloses a system and method for learning data values over time as they are entered by a user on a form such as a web page form. An Internet web browser can be modified to suggest previously used data values for any form field that is the same as or similar to a previously used form field. Application programs that use the web browser can gain access to previously used form field values even if they have no knowledge of the field names. Software in a web browser associates field names across different Universal Resource Locators (URLs), so that when a user enters a value into a field (e.g., username) at a first web site, that same value can be automatically suggested when the user displays a different form on a different web site that uses the same field name.

### SUMMARY OF THE INVENTION

The present invention provides a method and system for modifying a webpage. The system of the invention interacts with a web browser, and may be used to customize web browsing.

As used herein, the term “tag” refers to a portion of a webpage configured to receive a user input. The system of the invention comprises a tag classification module which infers the classification of one or more of the tags on the webpage. One or more tags classified by the tag classification module is input to a webpage modification module which modifies the properties of the webpage by adding a functionality to the webpage, where the functionality added to the webpage is determined by the classification of the tag.

The system of the invention may also comprise a tag detection module configured to detect tags on a web page. Tags detected by the tag detection module are input to the tag classification module. The tag detection module may scan the webpage code for code indicative of a tag.

In one embodiment of the classification module, the classification module scans the webpage code for code indicative of attributes of the tag from which a classification of the tag can be inferred. In another embodiment of the tag classification module, the tag classification module logs phrases input to a tag over a period of time by users visiting the webpage. A list of input phrases logged by the tag classification module is compiled by the tag classification module that is compared with one or more predetermined classified lists of phrases. A score of the comparison is calculated indicative of the similarity of the logged list and the predetermined classified list. The classification of the predetermined list having the highest score is then inferred to be the classification of the tag.

Tags classified by the tag classification module are input to a webpage modification module that adds one or more functionalities to the webpage according to the classification of one or more tags on the webpage. The functionality added to a webpage may be, for example, a menu of phrases relevant to the classification of a tag. A phrase in the menu may be selected and used in a search.

Thus, in its first aspect, the present invention provides a system for modifying a webpage comprising:
(a) a tag classification module configured to classify tags on a webpage; and (
b) a webpage modification module configured to add one or more predetermined functionalities to the webpage based upon the classification of one or more of the tags on the webpage classified by the tag classification module.

The system of the invention can be configured to be implemented through browser plug-in, a toolbar, or installed application.

The system according may further comprise a tag detection module that may be configured to scan webpage code for code indicative of a tag.

The classification module may be configured to scan webpage code for code indicative of attributes of a tag. The classification module may be further configured to infer a classification from one or more attributes of a tag. The tag classification module may be configured to log phrases input to a tag over a period of time, and may be configured to make a comparison between a list of input phrases logged by the tag classification module with each of one or more predetermined classified lists of items. The tag classification module may calculate a score for each of one or more of the comparison, and infer a classification of the tag based upon one or more of the scores. The calculation of a score may involve a number or fraction of common items on the logged list and the predetermined classified list. The tag classification module may infer that the classification of the tag is the classification of a predetermined classified list having a maximal score.

The functionality added to a webpage by the webpage modification module may be a menu of items associated with the classification of the tag. The functionality added to a webpage by the webpage modification module may be one or more activatable images associated with the classification of the tag. The functionality added to a webpage by the webpage modification module may be a toolbar, such as a toolbar of a music player.

In its second aspect, the present invention provides a method for modifying a webpage comprising:
(a) classifying tags on the webpage; and
(b) adding one or more predetermined functionalities to the webpage based upon the classification of one or more of the tags on the webpage classified by the tag classification module.

The method of the invention may be implemented through a browser plug-in, a toolbar, or an installed application.

The method of the invention may further comprise a step of detecting tags on the webpage. The step of detecting tags may comprise scanning webpage code for code indicative of a tag.

The step of classifying tags on the webpage may involve scanning webpage code for code indicative of attributes of a tag. The step of classifying tags may further involve inferring a classification from one or more attributes of a tag. The step of classifying tags may further involve inferring logging phrases input to a tag over a period of time. The step of classifying tags may further involve making a comparison between a list of input logged phrases with each of one or more predetermined classified lists of items. The step of classifying tags may further involve calculating a score for each of one or more of the comparison, and inferring a classification of the tag based upon one or more of the scores. The calculation of a score may involve a number or fraction of common items on the logged list and the predetermined classified list. The step of classifying tags may further involve inferring that the classification of the tag is the classification of a predetermined classified list having a maximal score.

The functionality added to a webpage may be a menu of items associated with the classification of the tag. The functionality added to a webpage may be one or more activatable images associated with the classification of the tag. The functionality added to a webpage may be a toolbar, such as a toolbar of a music player.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 shows a typical webpage;

FIG. 2 shows schematically a system for modifying a webpage in accordance with one embodiment of the invention;

FIG. 3 shows a portion of the code of a webpage;

FIG. 4 shows a database of classified lists of phrases and a database of entries logged in each of several tags; and

FIG. 5a shows functionality added to a webpage related to music and FIG. 5b shows functionality added to a webpage related to food.

### DETAILED DESCRIPTION OF EMBODIMENTS

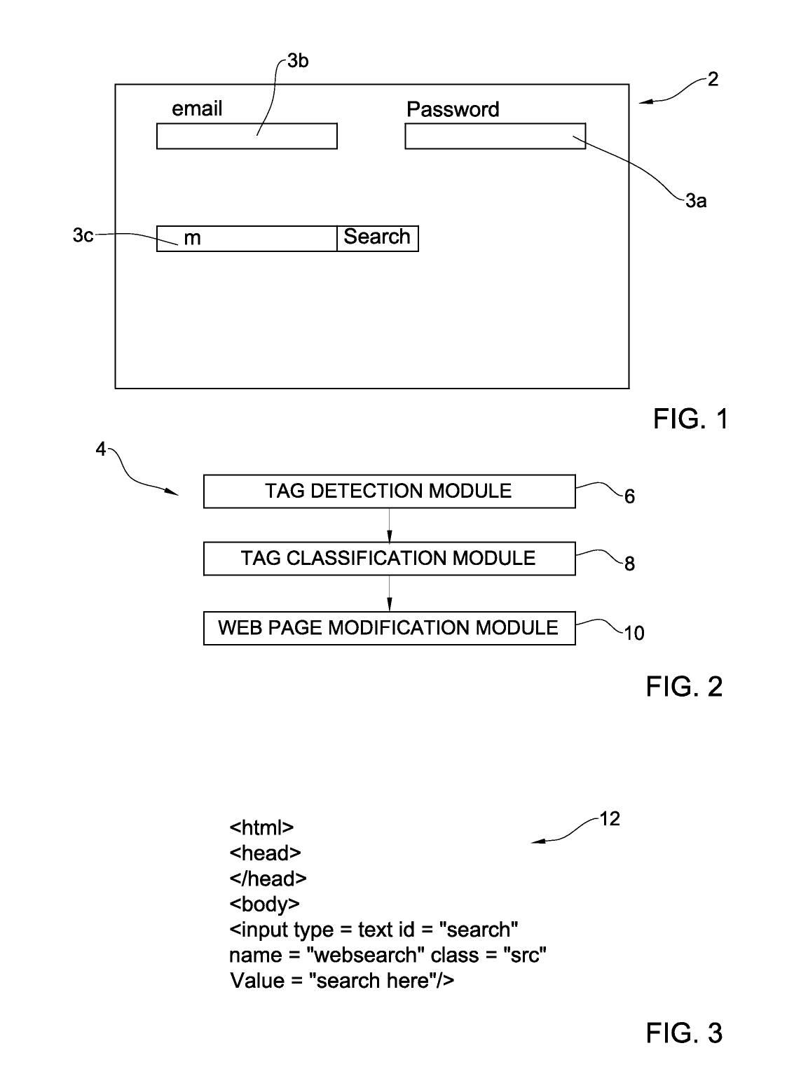

FIG. 1 shows a typical webpage 2 having one or more tags 3. Three tags, 3a, 3b and 3c, are shown in FIG. 1 by way of example only. Each of the tags 3 allows a user to input a string of characters. For example, a user may input a password into the password tag 3a, an email address into the email tag 3b, or a keyword into the search tag 3c.

FIG. 2 shows schematically a system 4 for modifying a webpage in accordance with one embodiment of the invention. The system 4 interacts with a web browser, and comprises a tag detection module 6 configured to detect tags on a web page. Referring again to FIG. 1, the tag detection would detect in the webpage 2 the three tags 3a, 3b, and 3c.

A list of the tags detected on a webpage by the tag detection module 6 is input to a tag classification module 8 which infers the classification of one or more of the tags in the input target list, as explained below. For example, in the webpage 2, the tag 3a could be classified by the classification module 8 as a “password tag”. The tags 3b and 3c could be classified as an “email tag” and a “search tag”, respectively. Any one or more of the classified tags is input to a webpage modification module which modifies the properties of the webpage by adding a functionality to the tag, where the functionality added to the tag is determined by the classification of the tag.

The system 4 may be delivered for example, through browser plug-ins, toolbars, or installed applications. As a webpage is loaded by the web browser the system can inject an input tag detection script to the websites code file. The script would then detect the webpage code for input tag candidates.

The tag detection module 6 scans a webpage code for code indicative of a tag. FIG. 3 shows a portion 12 of the code for the webpage 2. For example, in HTML code, the phrase “input type” may indicate the presence of a tag.

In one embodiment of the classification module 8 of the system 4, the classification module scans the webpage code for code indicative of attributes of the tag that from which a classification of the tag can be inferred. For example, in the portion 12 of the code shown in FIG. 3, the tag classification module could infer from the term “search” that the tag 3c (FIG. 1) is a search tag. Similarly, the tag classification module could infer that a tag having the attribute “music” should be classified as “music”.

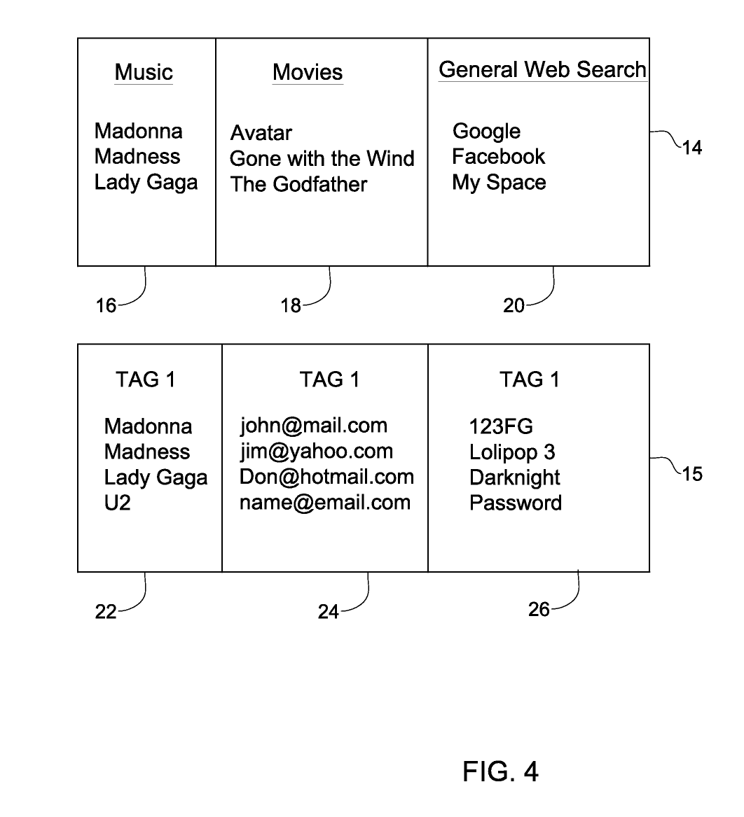

In another embodiment of the tag classification module 8, the tag classification module logs phrases input to a tag over a period of time by users visiting the webpage. A list of input phrases logged by the tag classification module is compiled by the tag classification module that is compared with one or more predetermined classified lists of phrases. FIG. 4 shows, by way of example, a database 14 comprising three classified lists of phrases. A “Music List” 16 includes the phrases “Madonna ”, “Madness ”, and “Lady Gaga ”. A “Movies List” 18 includes the phrases “Avatar”, “Gone with the Wind” and “The Godfather”. A “General Web Search List” 20 includes the phrases “Google”, “Facebook” and “Myspace”. Also shown in FIG. 4 is a database 15 including three lists of phrases 22, 24, and 26, compiled by logging phrases input into each of three tags. A list of phrases 22 input into a “Tag 1” includes the input phrases “Madonna”, “Madness”, “U2” and “Lady gaga”. The list 22 is compared with each of one or more of the predetermined classification lists in the database 14. In this example, the list 22 has at least three phrases in common with the Music List 16, and has no phrases in common with any of the other lists in the database 14. When the fraction of phrases common to a logged list and a predetermined list exceeds a predetermined threshold, the tag classification module infers that the classification of the logged list is the classification of the predetermined list in the database. The other tag lists 24 and 26 do not have any phrases in common with any of the predetermined lists in the database 14, and would not be classified by the tag classification module.

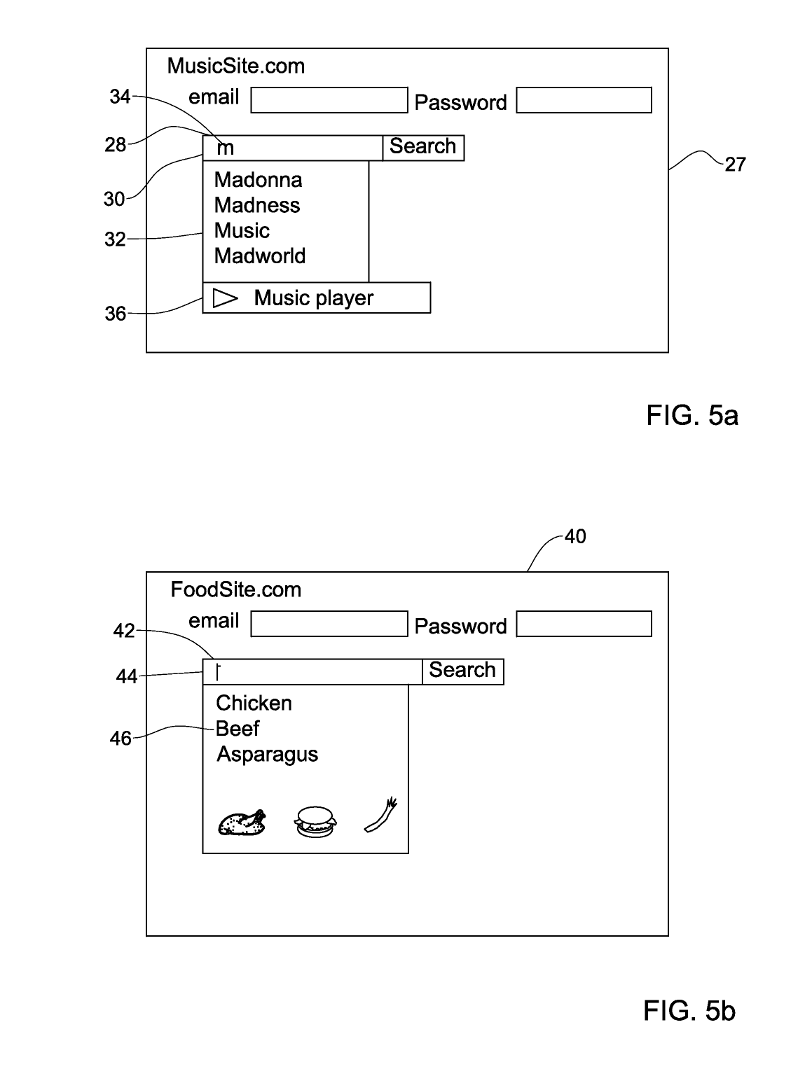

Any one or more of the tags classified by the tag classification module 8 can be input to the webpage modification module 10. FIG. 5 shows examples of functionalities added to a webpage based upon the classification of a tag on the page. As shown in FIG. 5a, in a webpage 27, a tag 28 has been classified by the tag classification module as being a music search tag. Positioning a cursor 30 in the tag 28 causes a menu 32 of phrases relevant to music to appear on the webpage. Inputting one or more characters 34 into the tag 28 may modify the menu 32. A phrase in the menu may be selected and used in a search. In addition, a toolbar 36 of a functional music player is displayed on the webpage that allows a user to play music selected from the search results.

As another example shown in FIG. 5b, in a webpage 40 a tag 42 has been classified by the classification module 8 as being a food search tag. Positioning a cursor 44 in the tag 42 causes a menu 46 of phrases relevant to food to appear on the webpage. A phrase in the menu may be selected and used in a search. In addition, pictures of one or more food items may be displayed on the webpage and selected by the user for use in a search.

1. A system for modifying a webpage comprising:
(a) a search input tag classification module configured to classify search input tags on the webpage; and
(b) a webpage modification module configured to add a keyword autocomplete functionality to the webpage based upon the classification of one or more of the search input tags on the webpage classified by the search input tag classification module.

2. The system according to claim 1 configured to be implemented through browser plug-in, a toolbar, or installed application.

3. The system according to claim 1 further comprising a search input tag detection module.

4. The system according to claim 3 wherein the search input tag detection module is configured to scan webpage code for code indicative of a search input tag.

5. The system according to claim 1 wherein the classification module is configured to scan webpage code for code indicative of attributes of a search input tag.

6. The system according to claim 5 wherein the classification module is further configured to infer a classification from one or more attributes of a search input tag.

7. The system according to claim 1 wherein the search input tag classification module is configured to log strings of characters input to a search input tag over a period of time.

8. The system according to claim 7 wherein the search input tag classification module is configured to make a comparison between a list of strings of characters logged by the search input tag classification module with each of one or more predetermined classified lists of items.

9. The system according to claim 8 wherein the search input tag classification module calculates a score for each of one or more of the comparison, and infers a classification of the search input tag based upon one or more of the scores.

10. The system according to claim 9 wherein the calculation of a score involves a number or fraction of common items on a list of logged strings of characters and the predetermined classified list.

11. The system according to claim 9 wherein the search input tag classification module infers that the classification of the search input tag is the classification of a predetermined classified list having a maximal score.

12. The system according to claim 1 further comprising adding to a webpage a menu of items—associated with the classification of the search input tag.

13. The system according to claim 1 further comprising adding to a webpage one or more activatable images associated with the classification of the search input tag.

14. The system according to claim 1 further comprising adding a toolbar to a webpage.

15. The system according to claim 14 wherein the toolbar is a toolbar of a music player.

16. A method for modifying a webpage comprising:
(a) classifying search input tags on the webpage; and
(b) adding a keyword autocomplete functionality to the webpage based upon the classification of one or more of the search input tags on the webpage.

17. The method according to claim 16 implemented through a browser plug-in, a toolbar, or an installed application.

18. The method according to claim 16 further comprising a step of detecting search input tags on the webpage.

19. The method according to claim 18 wherein the step of detecting search input tags comprises scanning webpage code for code indicative of a search input tag.

20. The method according to claim 16 wherein the step of classifying search input tags on the webpage involves scanning webpage code for code indicative of attributes of a search input tag.

21. The method according to claim 20 wherein the step of classifying search input tags further involves inferring a classification from one or more attributes of a search input tag.

22. The method according to claim 16 wherein the step of classifying search input tags further involves inferring logging strings of characters input to a search input tag over a period of time.

23. The method according to claim 22 wherein the step of classifying search input tags further involves making a comparison between a list of input logged strings of characters with each of one or more predetermined classified lists of items.

24. The method according to claim 23 wherein the step of classifying search input tags further involves calculating a score for each of one or more of the comparison, and infers a classification of the search input tag based upon one or more of the scores.

25. The method according to claim 24 wherein the calculation of a score involves a number or fraction of common items on a list of logged strings of characters and the predetermined classified list.

26. The method according to claim 24 wherein the step of classifying input tags further involves inferring that the classification of the search input tag is the classification of a predetermined classified list having a maximal score.

27. The method according to claim 16 further comprising adding to a webpage a menu of items associated with the classification of the search input tag.

28. The method according to claim 16 further comprising adding to a webpage one or more activatable images associated with the classification of the search input tag.

29. The method according to claim 16 further comprising adding a toolbar to a webpage.

30. The method according to claim 29 wherein the toolbar is a toolbar of a music player.
